(19) United States
(12) Patent Application Publication
(10) Pub. No.: US 2014/0059071 A1
(43) Pub. Date: Feb. 27, 2014

(54) METHODS, CIRCUITS, DEVICES, SYSTEMS AND ASSOCIATED COMPUTER EXECUTABLE CODE FOR PROVIDING DOMAIN NAME RESOLUTION

(71) Applicant: SAGUNA NETWORKS LTD., (US)

(72) Inventors: Daniel Nathan Frydman, Haifa (IL); Lior Fite, Zurit (IL)

(73) Assignee: SAGUNA NETWORKS LTD., Yokneam Illit (IL)

(21) Appl. No.: 13/739,067

(22) Filed: Jan. 11, 2013

Related U.S. Application Data
(60) Provisional application No. 61/585,251, filed on Jan. 11, 2012.

(51) Int. Cl. G06F 17/30

(52) U.S. Cl. CPC G06F 17/30424
USPC 707/769

(57) ABSTRACT

Disclosed are methods, circuits, devices, systems and associated computer executable code for providing Domain Name Resolution functionality to data client device accessing network data through an access point. According to some embodiments, an access point may be integral or otherwise functionally associated with a zone specific domain name system (ZSDNS, which ZSDNS may include a local cache of DNS records, which local cache of DNS records may be zone specific.

### CROSS REFERENCE

The present application claims the benefit of U.S. Provisional Patent Application 61/585,251 filed Jan. 11, 2011, the disclosure of which is incorporated herein by reference in its entirety.

### FIELD OF THE INVENTION

Some embodiments relate generally to the field of domain name systems and, more particularly, to methods, circuits, devices, systems and associated computer executable code for providing domain name resolution.

### BACKGROUND

Remote on-demand access to computer and communication network resources, including Internet access is widespread. With the Internet becoming increasingly popular, more network users are able to connect to a remote server through any device with an internet connection. Users are able to connect to the Internet from home computers, laptops, tablets, smart phones, e-book readers, and any other mobile Internet device. When connected to the internet, users often download or stream significant amounts of data from various data sources, such as websites, hosted on servers connected to the internet.

Data servers connected to a data network, such as the Internet, at one or more network nodes are typically identifiable and addressable using an Internet Protocol (e.g. IP v4 and v6) address. Websites and other data sources connected to the Internet are, however, typically associated with a server name or domain name. The Domain Name System (DNS) is a hierarchical distributed naming system for computers, services, or any resource connected to the Internet or a private network. It associates various information with domain names assigned to each of the participating entities. A Domain Name Service resolves queries for these names into IP addresses for the purpose of locating computer services and devices either on a local network or worldwide on the Internet. By providing a worldwide, distributed keyword-based redirection service, the Domain Name System is an essential component of the functionality of the Internet.

An often-used analogy to explain the Domain Name System is that it serves as the phone book for the Internet by translating human-friendly computer hostnames into IP addresses. For example, the domain name www.example.com translates to the addresses 192.0.43.10 (IPv4) and 2620:0:2d0:200::10 (IPv6). Unlike a phone book, DNS can be quickly updated and these updates are distributed, allowing a service's location on the network to change without affecting the end users, who continue to use the same hostname. Users take advantage of this when they recite meaningful Uniform Resource Locators (URLs) and e-mail addresses without having to know how the computer actually locates the services.

The Domain Name System distributes the responsibility of assigning domain names and mapping those names to IP addresses by designating authoritative name servers for each domain. Authoritative name servers are assigned to be responsible for their particular domains, and in turn can assign other authoritative name servers for their sub-domains. This mechanism has made the DNS distributed and fault tolerant and has helped avoid the need for a single central register to be continually consulted and updated. Additionally, the responsibility for maintaining and updating the master record for the domains is spread among many domain name registrars, who compete for the end-user's, domain-owner's, business. Domains can be moved from registrar to registrar at any time.

The Domain Name System also specifies the technical functionality of this database service. It defines the DNS protocol, a detailed specification of the data structures and communication exchanges used in DNS, as part of the Internet Protocol Suite.

The Internet maintains two principal namespaces, the domain name hierarchy and the Internet Protocol (IP) address spaces. The Domain Name System maintains the domain name hierarchy and provides translation services between it and the address spaces. Internet name servers and a communication protocol implement the Domain Name System. A DNS name server is a server that stores the DNS records for a domain name, such as address (A) records, name server (NS) records, and mail exchanger (MX) records (see also list of DNS record types); a DNS name server responds with answers to queries against its database.

The growing demand for packet data (e.g. TCP/IP) services over mobile networks, including: (1) mixed and rich content websites, (2) video and audio content streaming, has fostered enormous bandwidth and data traffic requirements for mobile communication/access networks. A single webpage may include URL's to multiple content sources, static and dynamic, and the loading of a single webpage may typically require between 15 and 20 DNS transactions with a remote DNS server. During peak network traffic hours, these requests may take between 3 and 4 seconds, thereby leading to a long delay in start of service and to customer frustration.

There is thus a need in the field of caching systems for improved methods, circuits, devices, systems and associated computer executable code for providing handling DNS transactions.

### SUMMARY OF THE INVENTION

The present invention may include a zone specific domain name system (ZSDNS) associated with an access point of a data access network. The ZSDNS may include a DNS query detector to detect DNS queries to a remote DNS server submitted by a data client device through said access point, control logic circuitry to search a local DNS cache for records relevant or responsive to the submitted query while allowing the submitted query to pass to the remote DNS server, and a DNS query responder to respond to the DNS query of the data client device in the event records relevant or responsive to the submitted query are identified in said local cache. According to some embodiments, there ZSDNS may include a local DNS database cache updater to update the local cache with information from a response received from the remote DNS cache. Updating may include amending a record of the local DNS cache and/or updating may include appending new records to the local DNS cache.

Some embodiments of the present invention include a data access network comprising a set of access points to provide network access to data client devices and a zone specific domain name system (DNS) associated with one or more of the access points and comprising.

The present invention includes methods, circuits, devices, systems and associated computer executable code for providing domain name resolution for network data applications (e.g. web browsers) running on data client devices (e.g. smartphones) connecting to a network through an access point. The access point may be a wireless access point such as a WiFi access point or a cellular network base-station or a cellular network cell-site. According to further embodiments, a DNS server, database and/or cache, integral or otherwise functionally associated with one or more access points, may provide domain name resolution services to a data client requesting DNS service through any of the one or more access points. The access point associated DNS server, database and/or case may be referred to as a Zone Specific Domain Name System (ZSDNS).

According to embodiments, a ZSDNS may provide location specific responses to DNS queries submitted by a data client device based on a location or region of the data client device accessing the localized DNS. A location or region of the data client may be estimated to be somewhere in the coverage area of the access point. Alternatively, the location may be more accurately estimated using localization (e.g. Direction of Arrival Detection, Signal Strength Detection, Triangulation, etc.) circuitry of the access point. According to yet further embodiments, ZSDNS may provide location specific responses to DNS queries based on a geographic location or region of the access point associated with the local ZSDNS, such that any data client device submitting a DNS query through a specific access point is assumed to be in a generally vicinity defined by a coverage area of the specific access point. The geographic location of the date client device may be assumed to be generally the same as the geographic location of the access point through which the data client device summited the DNS query.

According to some embodiments, the ZSDNS may include: (1) a DNS query detector, (2) a local DNS database cache, (3) control logic circuitry (4) a DNS query responder, (5) a remote DNS response interceptor, and (6) a local DNS database cache updater. The DNS query detector may detect a DNS query submitted to a remote DNS server by data client device connected to an access point with which the DNS query detector is functionally associated. ZSDNS control logic circuitry may use the detected query to search the local DNS database cache for one or more DNS records which may provide a resolution to the detected DNS query. The submitted query may concurrently either be forwarded or allowed to pass to the remote DNS server to which the query was addressed by the data client device. In the event one or more records responsive to the DNS query are identified in the local cache: (a) the DNS query responder may generate and transmit to the data client device a DNS query response indicative of DNS resolution information contained within the identified record(s); (b) any DNS query response received from the remote DNS server may be intercepted and blocked by a remote DNS response interceptor such that it is not received by the query submitting data client device; and (c) the DNS query response received from the remote DNS may be used by the local DNS database cache updater to update the one or more corresponding records in the local DNS cache. In the event one or more records responsive to the DNS query are not identified in the local cache: (a) any DNS query response received from the remote DNS server may be forwarded or allowed to pass by the interceptor to the data client device; and (b) the DNS query response received from the remote DNS may be used by the local DNS database cache updater for generating new DNS records in the local DNS cache reflective of the DNS resolution information contained within the response received from the remote DNS server.

All of the ZSDNS activities may be coordinated and/or regulated by control logic circuitry, which circuitry may either be dedicated circuitry, for example a controller chip, or may be code executed on a general purpose processor. Any of the above mentioned functional blocks and their respective functions may be integrated with any one or more of the functional block.

According to some embodiments where the access points are cellular base stations or cell-sites, the ZSDNS may include a packet data (e.g. TCP/IP) tunnel detector and optionally a mobile tunnel interceptor/generator (e.g. GTP-U) for providing the above mentioned DNS query manipulations on data client devices accessing internet resources through the cellular network.

According to further embodiments, DNS records contained within the local DNS cache may be location specific and optionally date, time or environmental condition specific. More specifically, an IP address provided by the local DNS cache in response to a given domain or URL may vary depending upon factors such as location of the data client device, time of day at the data client device's location, date at the data client device's location, day of the week at the data client device's location, and environmental conditions (e.g. temperature, weather conditions, etc.) at the data client device's location. Additionally, an IP address provided by the local DNS cache in response to a given domain or URL may vary depending upon a network operator's commercial preferences. For example, advertising selection/insertion/injection (e.g. banners, links, etc.) may be performed by the operator through local DNS record manipulations, and the advertising content selected by the operator may be that advertising deemed commercially valuable to the operator. According to some embodiments, the local DNS database cache updater may include an Application Interface (API) for enabling the network operator, owner or other authorized party to update the local DNS database with predefined DNS responses for specific requests, as described above.

According to some embodiments, the present invention provides for DNS query resolution from one or more points in proximity to a customer using a smartphone as a data client device, namely in or near the cell-site being used. Moving DNS resolution capability closer to the data client device may lead to a shortening of the start of data services (e.g. website downloading) to only several 10's of ms. Said approach may also enable a unique implementation of location based advertisement and other location based services without the need to extract any location information from the data client device itself.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1A is a conceptual network diagram of an exemplary access network including zone specific domain name systems according to embodiments;

FIG. 1B shows a network level diagram of a mobile (cellular) communications network including multiple access points (base stations) through which data clients may access internet resources and further include zone specific domain name systems functionally linked to the access points;

FIG. 2A shows a general system level diagram of an exemplary zone specific domain name system integrated into a network access point according to embodiments;

FIG. 2B is a flow chart including steps of an exemplary method for providing zone specific domain name resolution as may be provided by a ZSDNS according to embodiments; and

FIG. 2C is signal/information flow diagram corresponding to FIGS. 2A and 2B.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices. In addition, the term “plurality” may be used throughout the specification to describe two or more components, devices, elements, parameters and the like.

It should be understood that some embodiments may be used in a variety of applications. Although embodiments of the invention are not limited in this respect, one or more of the methods, devices and/or systems disclosed herein may be used in many applications, e.g., civil applications, military applications, medical applications, commercial applications, or any other suitable application.

Some embodiments of the invention, for example, may take the form of an entirely hardware embodiment, an entirely software embodiment, or an embodiment including both hardware and software elements. Some embodiments may be implemented in software, which includes but is not limited to firmware, resident software, microcode, or the like.

Furthermore, some embodiments of the invention may take the form of a computer program product accessible from a computer-usable or computer-readable medium providing program code for use by or in connection with a computer or any instruction execution system. For example, a computer-usable or computer-readable medium may be or may include any apparatus that can comprise, store, communicate, propagate, or transport the program for use by or in connection with the instruction execution system, apparatus, or device.

In some embodiments, the medium may be an electronic, magnetic, optical, electromagnetic, infrared, or semiconductor system (or apparatus or device) or a propagation medium. Some demonstrative examples of a computer-readable medium may include a semiconductor or solid state memory, magnetic tape, a removable computer diskette, a random access memory (RAM), a read-only memory (ROM), a rigid magnetic disk, and an optical disk. Some demonstrative examples of optical disks include compact disk-read only memory (CD-ROM), compact disk-read/write (CD-R/W), and DVD.

In some embodiments, a data processing system suitable for storing and/or executing program code may include at least one processor coupled directly or indirectly to memory elements, for example, through a system bus. The memory elements may include, for example, local memory employed during actual execution of the program code, bulk storage, and cache memories which may provide temporary storage of at least some program code in order to reduce the number of times code must be retrieved from bulk storage during execution.

In some embodiments, input/output or I/O devices (including but not limited to keyboards, displays, pointing devices, etc.) may be coupled to the system either directly or through intervening I/O controllers. In some embodiments, network adapters may be coupled to the system to enable the data processing system to become coupled to other data processing systems or remote printers or storage devices, for example, through intervening private or public networks. In some embodiments, modems, cable modems and Ethernet cards are demonstrative examples of types of network adapters. Other suitable components may be used.

The present invention includes methods, circuits, devices, systems and associated computer executable code for providing domain name resolution for network data applications (e.g. web browsers) running on data client devices (e.g. smartphones) connecting to a network through an access point. The access point may be a wireless access point such as a WiFi access point or a cellular network base-station or a cellular network cell-site. According to further embodiments, a DNS server, database and/or cache, integral or otherwise functionally associated with one or more access points, may provide domain name resolution services to a data client requesting DNS service through any of the one or more access points. The access point associated DNS server, database and/or case may be referred to as a Zone Specific Domain Name System (ZSDNS).

According to embodiments, a ZSDNS may provide location specific responses to DNS queries submitted by a data client device based on a location or region of the data client device accessing the localized DNS. A location or region of the data client may be estimated to be somewhere in the coverage area of the access point. Alternatively, the location may be more accurately estimated using localization (e.g. Direction of Arrival Detection, Signal Strength Detection, Triangulation, etc.) circuitry of the access point. According to yet further embodiments, ZSDNS may provide location specific responses to DNS queries based on a geographic location or region of the access point associated with the local ZSDNS, such that any data client device submitting a DNS query through a specific access point is assumed to be in a generally vicinity defined by a coverage area of the specific access point. The geographic location of the date client device may be assumed to be generally the same as the geographic location of the access point through which the data client device summited the DNS query.

According to some embodiments, the ZSDNS may include: (1) a DNS query detector, (2) a local DNS database cache, (3) control logic circuitry (4) a DNS query responder, (5) a remote DNS response interceptor, and (6) a local DNS database cache updater. The DNS query detector may detect a DNS query submitted to a remote DNS server by data client device connected to an access point with which the DNS query detector is functionally associated. ZSDNS control logic circuitry may use the detected query to search the local DNS database cache for one or more DNS records which may provide a resolution to the detected DNS query. The submitted query may concurrently either be forwarded or allowed to pass to the remote DNS server to which the query was addressed by the data client device. In the event one or more records responsive to the DNS query are identified in the local cache: (a) the DNS query responder may generate and transmit to the data client device a DNS query response indicative of DNS resolution information contained within the identified record(s); (b) any DNS query response received from the remote DNS server may be intercepted and blocked by a remote DNS response interceptor such that it is not received by the query submitting data client device; and (c) the DNS query response received from the remote DNS may be used by the local DNS database cache updater to update the one or more corresponding records in the local DNS cache. In the event one or more records responsive to the DNS query are not identified in the local cache: (a) any DNS query response received from the remote DNS server may be forwarded or allowed to pass by the interceptor to the data client device; and (b) the DNS query response received from the remote DNS may be used by the local DNS database cache updater for generating new DNS records in the local DNS cache reflective of the DNS resolution information contained within the response received from the remote DNS server.

All of the ZSDNS activities may be coordinated and/or regulated by control logic circuitry, which circuitry may either be dedicated circuitry, for example a controller chip, or may be code executed on a general purpose processor. Any of the above mentioned functional blocks and their respective functions may be integrated with any one or more of the functional block.

According to some embodiments where the access points are cellular base stations or cell-sites, the ZSDNS may include a packet data (e.g. TCP/IP) tunnel detector and optionally a mobile tunnel interceptor/generator (e.g. GTP-U) for providing the above mentioned DNS query manipulations on data client devices accessing internet resources through the cellular network.

According to further embodiments, DNS records contained within the local DNS cache may be location specific and optionally date, time or environmental condition specific. More specifically, an IP address provided by the local DNS cache in response to a given domain or URL may vary depending upon factors such as location of the data client device, time of day at the data client device's location, date at the data client device's location, day of the week at the data client device's location, and environmental conditions (e.g. temperature, weather conditions, etc.) at the data client device's location. Additionally, an IP address provided by the local DNS cache in response to a given domain or URL may vary depending upon a network operator's commercial preferences. For example, advertising selection/insertion/injection (e.g. banners, links, etc.) may be performed by the operator through local DNS record manipulations, and the advertising content selected by the operator may be that advertising deemed commercially valuable to the operator. According to some embodiments, the local DNS database cache updater may include an Application Interface (API) for enabling the network operator, owner or other authorized party to update the local DNS database with predefined DNS responses for specific requests, as described above.

According to some embodiments, the present invention provides for DNS query resolution from one or more points in proximity to a customer using a smartphone as a data client device, namely in or near the cell-site being used. Moving DNS resolution capability closer to the data client device may lead to a shortening of the start of data services (e.g. website downloading) to only several 10's of ms. Said approach may also enable a unique implementation of location based advertisement and other location based services without the need to extract any location information from the data client device itself.

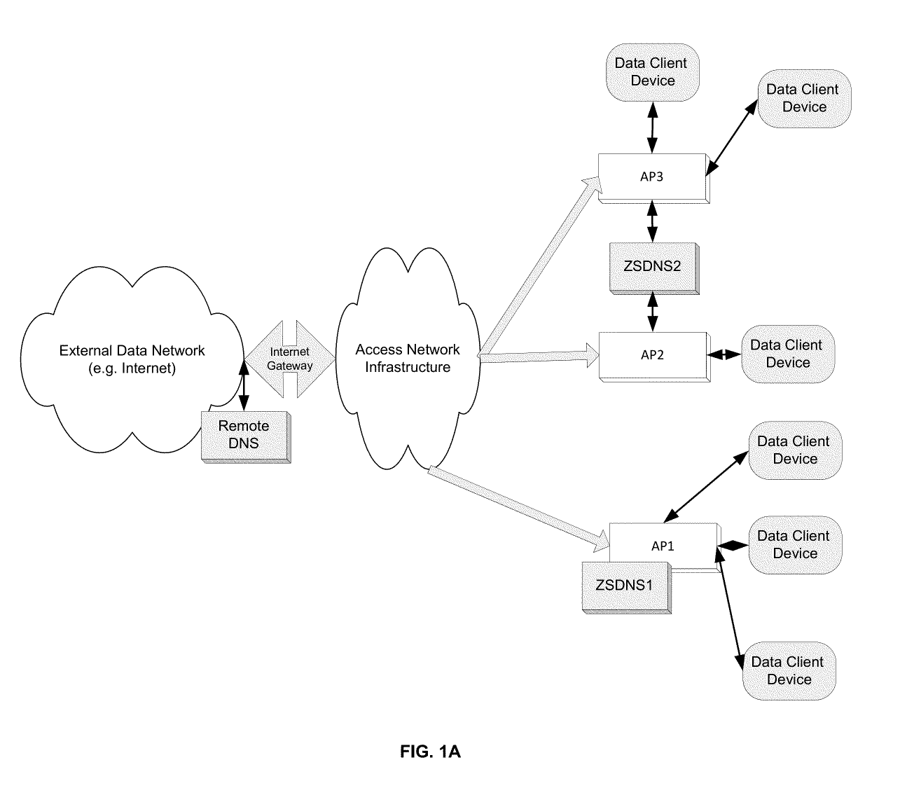

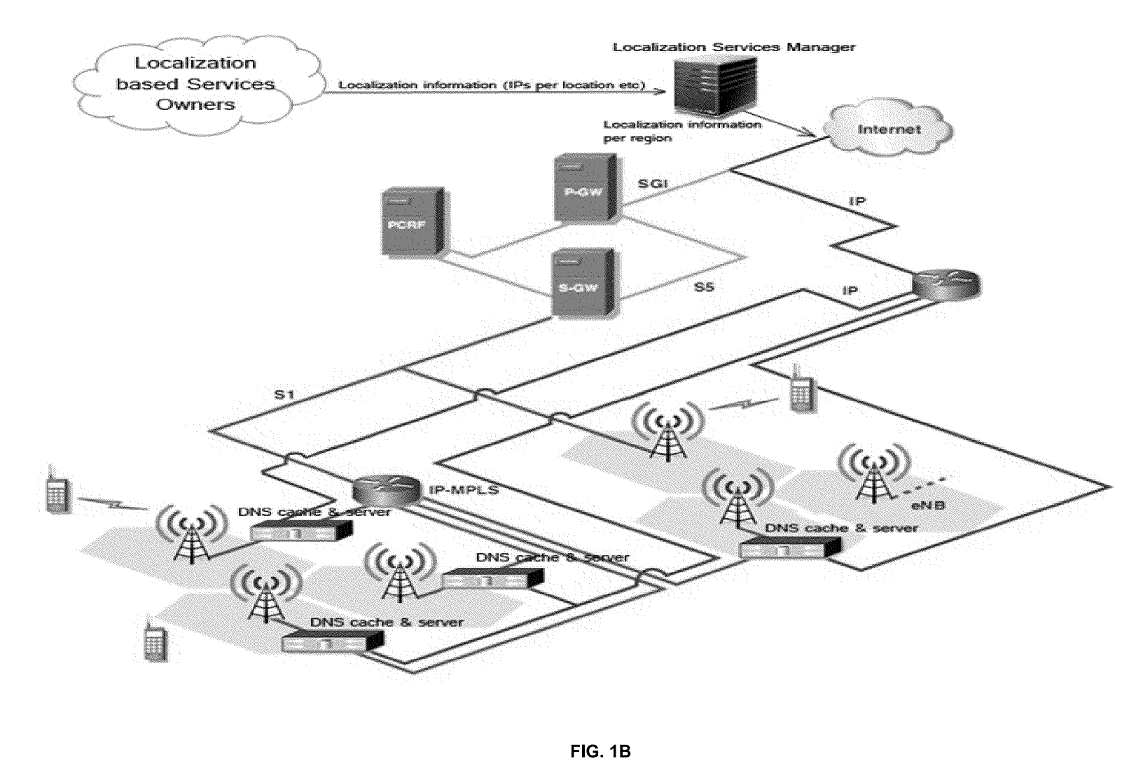

Turning now to FIG. 1A, there is shown is a conceptual network diagram of an exemplary access network including zone specific domain name systems according to embodiments. A first ZSDNS, labeled ZSDNS1, is shown substantially integrated with a first access point (API) and a second ZSDNS, labeled ZSDNS2, is shown functionally associated with two AP's, AP2 and AP3. The ZSDNS's function as described above and provide first level DNS resolution services to data client devices connect to their respective AP's. In the event a DNS query cannot be resolved a given ZSDNS, a response from a remote DNS may be forwarded to the query submitting data client device. FIG. 1B shows a network level diagram of a mobile (cellular) communications network embodiment of the present invention including multiple access points (base stations) through which data clients may access internet resources and further. Some of the network base-stations include zone specific domain name systems, therein denoted as “DNS cache & server”. FIG. 1B also shows a localization services manager providing network access to localization based services owners/providers.

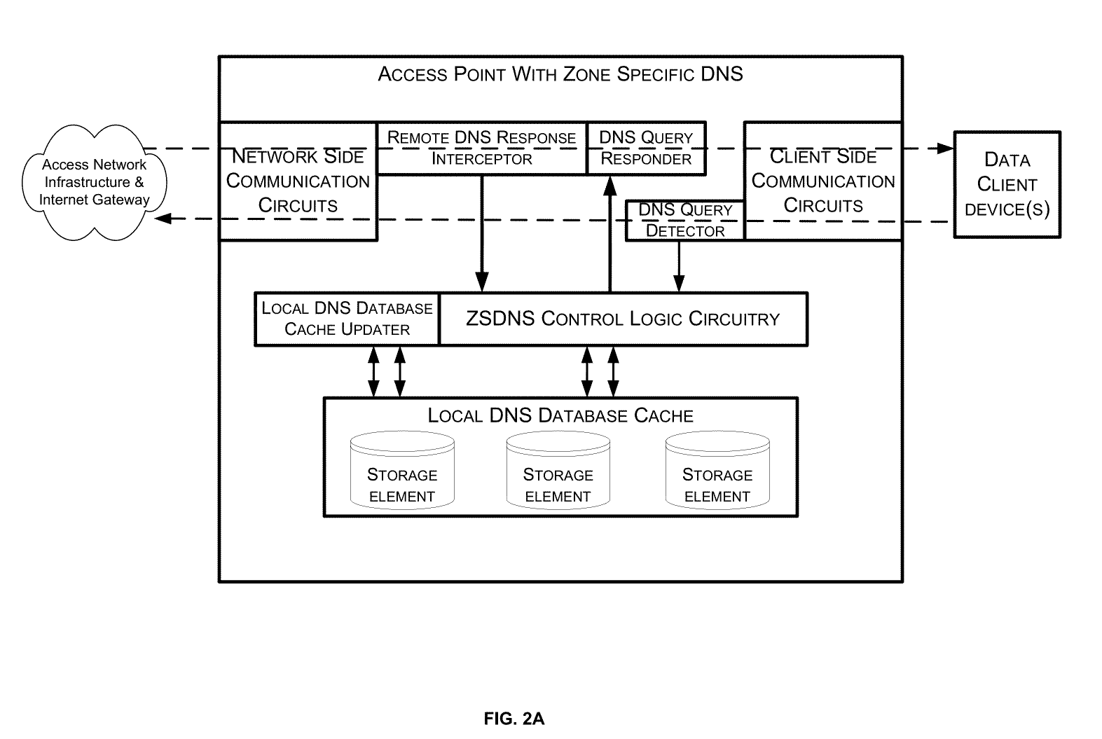

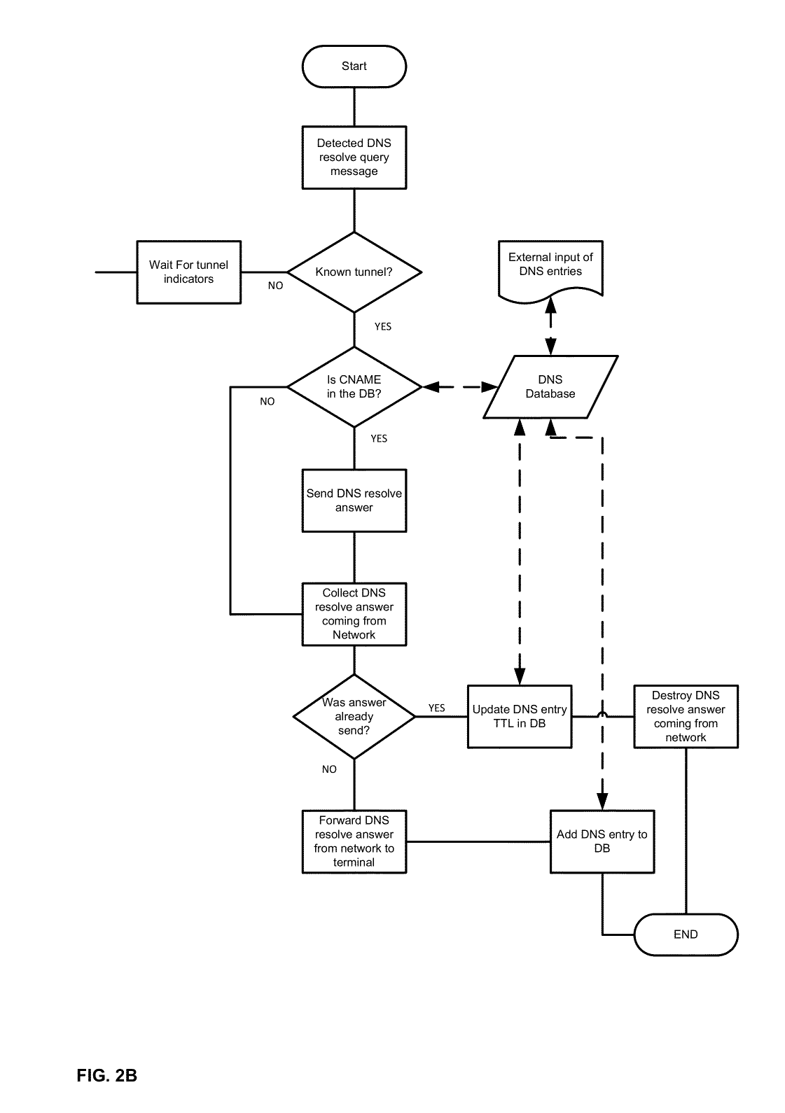

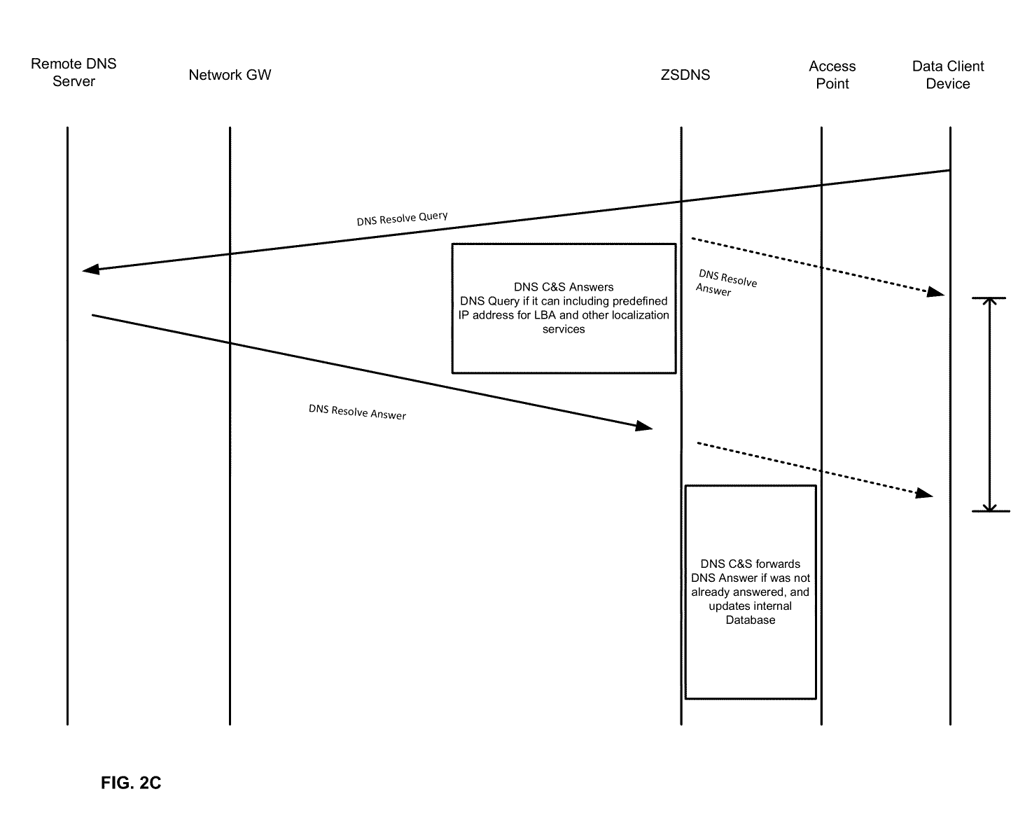

Turning now to FIG. 2A, there is show a general system level diagram of an exemplary zone specific domain name system integrated into a network access point according to embodiments. A description of the operation of the ZSDNS of FIG. 2A may be make in conjunction with the flowchart of FIG. 2B, including steps of an exemplary method for providing zone specific domain name resolution as may be provided by a ZSDNS according to embodiments, and further in conjunction with the signal/information flow diagram or FIG. 2C. The access point with ZSDNS of FIG. 2A includes: (1) a DNS query detector, (2) a local DNS database cache, (3) control logic circuitry (4) a DNS query responder, (5) a remote DNS response interceptor, and (6) a local DNS database cache updater. The DNS query detector may detect a DNS query submitted to a remote DNS server by data client device connected to an access point with which the DNS query detector is functionally associated. ZSDNS control logic circuitry may use the detected query to search the local DNS database cache for one or more DNS records which may provide a resolution to the detected DNS query. The submitted query may concurrently either be forwarded or allowed to pass to the remote DNS server to which the query was addressed by the data client device. In the event one or more records responsive to the DNS query are identified in the local cache: (a) the DNS query responder may generate and transmit to the data client device a DNS query response indicative of DNS resolution information contained within the identified record(s); (b) any DNS query response received from the remote DNS server may be intercepted and blocked by a remote DNS response interceptor such that it is not received by the query submitting data client device; and (c) the DNS query response received from the remote DNS may be used by the local DNS database cache updater to update the one or more corresponding records in the local DNS cache. In the event one or more records responsive to the DNS query are not identified in the local cache: (a) any DNS query response received from the remote DNS server may be forwarded or allowed to pass by the interceptor to the data client device; and (b) the DNS query response received from the remote DNS may be used by the local DNS database cache updater for generating new DNS records in the local DNS cache reflective of the DNS resolution information contained within the response received from the remote DNS server.

The ZSDNA may support an internal mechanism (table or other) to convert URLs to predefined IP addresses. There may be provided an API via which a remote management system may configure this internal mechanism. This configuration may be done using standard management protocols such as SNMP, Web interface, or any other standard files (Excel or other) which contain all the required localization information, or by any other configuration means. This capability enables the owners of the advertisements and web content to predefine what information will be distributed to users at each region.

According to further embodiment, the ZSDNS system may run in tunneled areas of the network supporting any type on tunnel such as L2TP, GTP, PPP, IuPS, IuB etc. The ZSDNS system may listen on all traffic coming from a terminal through a network end point (cell site or other) on UDP port 53 or any other port assigned for DNS services in the network to detect DNS requests. Per each DNS request the system will try to generate a response locally using cached DNS responses for the identical DNS requests, and the tunnel header which corresponds to the terminals tunnel. Into these responses the system may (if preconfigured) insert the localization information thus passing to the terminal IP addresses of content that are relevant for that region. In any case, the DNS request is sent all the way to the original DNS server for support of billing and lawful interception. If the DNS response can't be generated locally by the DNS cache & server, the DNS response coming from the original server shall be sent to the terminal.

Functions, operations, components and/or features described herein with reference to one or more embodiments, may be combined with, or may be utilized in combination with, one or more other functions, operations, components and/or features described herein with reference to one or more other embodiments, or vice versa.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. A zone specific domain name system (ZSDNS) associated with an access point of a data access network, said system comprising:
a DNS query detector to detect DNS queries to a remote DNS server submitted by a data client device through said access point;
control logic circuitry to search a local DNS cache for records relevant or responsive to the submitted query while allowing the submitted query to pass to the remote DNS server; and
a DNS query responder to respond to the DNS query of the data client device in the event records relevant or responsive to the submitted query are identified in said local cache.

2. The system according to claim 1, further comprising a local DNS database cache updater to update said local cache with information from a response received from the remote DNS cache.

3. The system according to claim 2, wherein updating includes amending a record of the local DNS cache.

4. The system according to claim 2, wherein updating includes appending new records to the local DNS cache.

5. A method of providing zone specific domain name system (DNS) services on a data access network having access points, said method comprising:
detecting a DNS query to a remote DNS server submitted by a data client device through an access point;
searching a local DNS cache for records relevant or responsive to the submitted query while allowing the submitted query to pass to the remote DNS server; and
responding to the DNS query of the data client device in the event records relevant or responsive to the submitted query are identified in the local cache.

6. The method according to claim 5, further comprising updating a local cache with information from a response received from the remote DNS cache.

7. The method according to claim 6, wherein updating includes amending a record of the local DNS cache.

8. The method according to claim 6, wherein updating includes appending new records to the local DNS cache.

9. A data access network comprising:
a set of access points to provide network access to data client devices; and
a zone specific domain name system (DNS) associated with one or more of said access points and comprising:
a DNS query detector to detect DNS queries to a remote DNS server submitted by a data client device through said access point;
control logic circuitry to search a local DNS cache for records relevant or responsive to the submitted query while allowing the submitted query to pass to the remote DNS server; and
a DNS query responder to respond to the DNS query of the data client device in the event records relevant or responsive to the submitted query are identified in said local cache.
